(19) United States
(12) Patent Application Publication
(10) Pub. No.: US 2026/0036458 A1
(43) Pub. Date: Feb. 5, 2026

(54) THROUGHFLOW MEASUREMENT SYSTEM

(71) Applicant: Endress+Hauser SICK GmbH+Co. KG, Ottendorf-Okrilla (DE)

(72) Inventors: Gerry SCHRÖTER, Dresden (DE); Marcel PANICKE, Ohorn (DE); Gerald KALLISCH, Dresden (DE)

(21) Appl. No.: 19/288,459

(22) Filed: Aug. 1, 2025

(30) Foreign Application Priority Data
Aug. 2, 2024 (EP) 24192498.4

(51) Int. Cl. G01F 15/18; G01F 1/66; G01F 1/667; G01F 15/14

(52) U.S. Cl. CPC G01F 15/18; G01F 1/662; G01F 1/667; G01F 15/14

(57) ABSTRACT

A throughflow measurement system for measuring a fluid throughflow in a fluid line comprises a housing, which has a fluid channel and which defines a channel axis by means of the course of the fluid channel, and at least one ultrasonic probe that can be fastened to the housing and that has a radiation direction, wherein, for fastening the ultrasonic probe to the housing, a fastening stub is provided that is welded to the outer wall of the housing and that has a receiver for the ultrasonic probe, wherein the radiation direction of the ultrasonic probe extends obliquely to the channel axis when the ultrasonic probe is arranged in the receiver. The fastening stub has a lateral surface that revolves around a stub axis extending at a right angle to the channel axis and that extends, starting from a housing-side end region of the fastening stub, in the direction of the stub axis, wherein a peripheral weld seam is formed in the transition region between the lateral surface of the fastening stub and the outer wall of the housing.

The invention relates to a throughflow measurement system for measuring a fluid throughflow in a fluid line, in particular in a high pressure line, said throughflow measurement system comprising: a housing, which has a fluid channel and which defines a channel axis by means of the course of the fluid channel, and at least one ultrasonic probe that can be fastened to the housing and that has a radiation direction, wherein, for fastening the ultrasonic probe to the housing, a fastening stub is provided that is welded to the outer wall of the housing and that has a receiver for the ultrasonic probe, wherein the radiation direction of the ultrasonic probe extends obliquely to the channel axis when the ultrasonic probe is arranged in the receiver.

In many areas of technology, measurements are to be performed on flowing fluids, i.e. gases or liquids. For example, flow rates of flowing fluids in pipelines can be determined by means of ultrasonic measurement technology in accordance with the transit time difference method. The volume flow of the fluid flowing through the pipeline can be determined on the basis of the determined flow rate and the known cross-sectional surface of the pipeline. Such volume flow measurement apparatus are frequently used in the form of meters to determine delivery quantities and/or consumption quantities of gases or liquids.

Due to the slanted course of the radiation direction in relation to the channel axis, a measurement path with a component in or against the flow direction results, which is important for determining the axial flow velocity. However, the slanted position of the ultrasonic probe is problematic with respect to the fastening to the housing, especially if it is to be suitable for high pressure.

For example, a cylindrical fastening stub can be welded to the housing obliquely to the channel axis and the ultrasonic probe can be arranged in alignment with the fastening stub, i.e. it can, for example, be seated in the longitudinal orientation in the fastening stub. Such an arrangement is, for example, disclosed in CN 212082488 U1. However, due to the slanted position of the fastening stub, this is associated with the risk of an uneven weld seam and an undesirable distortion, which necessitates costly reworking in many cases.

Stubs oriented obliquely to the channel axis can also be created by reshaping or by casting. However, this is likewise associated with a high production effort. In the high-pressure range, the wall thickness of the housing is usually so great that reshaping techniques can be ruled out anyway.

To avoid an oblique orientation of the fastening stub to the channel axis, a cranked ultrasonic probe could also be used, i.e. an ultrasonic probe that has a bend so that the radiation direction extends obliquely to the probe axis. However, such probes are relatively expensive. Furthermore, the positioning with the desired accuracy is difficult.

It is an object of the invention to provide a throughflow measurement system of the aforementioned kind that ensures a precise and stable positioning of the ultrasonic probe by simple means and preferably without mechanical reworking.

The object is satisfied by a throughflow measurement system having the features of claim 1.

According to the invention, the fastening stub has a lateral surface that revolves around a stub axis extending at a right angle to the channel axis and that extends, starting from a housing-side end region of the fastening stub, in the direction of the stub axis, wherein a peripheral weld seam is formed in the transition region between the lateral surface of the fastening stub and the outer wall of the housing.

Thus, at least the part of the fastening stub facing the housing can be oriented at a right angle to the channel axis, which facilitates the welding process, and, in particular in contrast to a fastening stub welded obliquely to the housing, enables a comparatively uniform welding geometry, in particular a uniform welding gap and a uniform weld seam. The distortion of the fastening stub during cooling is minimized. It has been found that a particularly accurate positioning of the ultrasonic probe is ensured with a throughflow measurement system according to the invention even if the fastening stub is welded to the housing in an automated manner and without reworking.

If the housing has a round cross-section, the transition region between the lateral surface of the fastening stub and the outer wall of the housing is curved so that the course of the peripheral weld seam in principle has an axial variation with respect to the stub axis. This axial variation is the smaller the larger the diameter of the housing and the smaller the diameter of the lateral surface of the fastening stub is. In many applications, the fluid line is so large in comparison to the fastening stub that the curvature of the transition region is practically negligible and has virtually no effect on the welding. To achieve a weld seam course without any axial variation, the curved housing wall can possibly also be provided with a planar surface section in the weld region. A further improvement of the welding process is thereby possible and the fastening stub has a geometry that is easy to produce. The planar surface section can be formed as a cut-out in the material of the housing in the region of the fastening stub or can alternatively be applied as a base to the material of the housing in the region of the fastening stub.

The housing of the throughflow measurement system can be designed as a component to be inserted into the fluid line or can itself form a section of the fluid line.

One embodiment of the invention provides that the lateral surface has a cylindrical shape and defines a cylindrical axis that extends in parallel with the stub axis and preferably coincides therewith. Such an at least partly cylindrically shaped fastening stub is particularly easy to manufacture.

The fastening stub can have at least one contact surface, in particular a planar contact surface, for the ultrasonic probe, said contact surface extending obliquely to the stub axis, to thus ensure an oblique orientation of the ultrasonic probe despite a perpendicular orientation of the fastening stub.

The fastening stub preferably has a planar clamping tool engagement surface that extends at a right angle to the stub axis. The fastening stub can thus be clamped in a perpendicular orientation against the housing using simple means, such as screw clamps, during the welding process. A planar clamping tool engagement surface is particularly advantageous in the case of two fastening stubs arranged opposite one another since the parallel engagement surfaces can then be clamped towards one another.

The ultrasonic probe can have a longitudinal axis coinciding with the radiation direction and a signal transmission surface extending at a right angle to the longitudinal axis. In contrast to a cranked ultrasonic probe, an ultrasonic probe radiating in a straight line is available at low cost and is easy to position.

At least one spacer preferably projects from the outer wall of the housing and contacts a boundary surface of the fastening stub. Such a spacer ensures that a defined welding gap is present for the welding process. Furthermore, a spacer enables particularly high clamping forces. The at least one spacer can be bolt-shaped and can be inserted into a bolt receiver of the housing. At least two spacers preferably project from the outer wall of the housing and contact a boundary surface or respective boundary surfaces of the fastening stub. In particular, exactly two spacers can be provided that are preferably arranged disposed opposite one another with respect to a passage hole for ultrasonic signals of the ultrasonic probe.

Furthermore, at least one positioning pin can project from the outer wall of the housing and is received in a pin receiver of the fastening stub. This ensures a simple and precise positioning of the fastening stub relative to the housing. At least two positioning pins preferably project from the outer wall of the housing and are received in respective pin receivers of the fastening stub. In particular, exactly two positioning pins can be provided that are preferably arranged disposed opposite one another with respect to a passage hole for ultrasonic signals of the ultrasonic probe.

At least one passage hole, which is in alignment with the receiver, for ultrasonic signals of the ultrasonic probe is preferably formed in the housing. Spacers and positioning pins as described above can be arranged distributed around the passage hole.

The throughflow measurement system can have at least one further ultrasonic probe that can be fastened to the housing, wherein a measurement path extending obliquely to the channel axis is formed between the two ultrasonic probes fastened to the housing. Depending on the application, two or more pairs of ultrasonic probes can also be provided to form a corresponding number of measurement paths. In principle, it is also possible for a reflection measurement path to be spanned by two ultrasonic probes and a reflector.

It may be that the housing is at least sectionally tubular and is preferably provided with screw flanges at both ends. The tube axis of the tubular section can in this respect coincide with the channel axis. Such a housing can be easily designed as suitable for high pressure and can accordingly be inserted into a high-pressure line.

The invention also relates to a method for fastening an ultrasonic probe, which has a radiation direction, to a housing that has a fluid channel and that defines a channel axis by means of the course of the fluid channel.

The method according to the invention comprises the steps:
providing a fastening stub that has a receiver for the ultrasonic probe and a lateral surface that revolves around a stub axis and that extends, starting from an end region of the fastening stub, in the direction of the stub axis,
positioning the fastening stub relative to the housing such that there is an air gap between the end region and the outer wall of the housing and the stub axis extends at a right angle to the channel axis,
welding the fastening stub to the outer wall of the housing while forming a peripheral weld seam in the region of the air gap, and
inserting the ultrasonic probe into the receiver of the fastening stub such that the radiation direction of the ultrasonic probe extends obliquely to the stub axis.

The fastening stub is therefore not fixedly welded obliquely to the housing, but at a right angle to the housing. The oblique orientation of the ultrasonic signals relative to the channel axis is not caused by an oblique orientation of the fastening stub, but rather by an oblique orientation of the ultrasonic probe relative to the fastening stub. Since the lateral surface adjoining the air gap has a uniform orientation with the wall of the housing, there is a uniform weld seam geometry, whereby the distortion occurring during the cooling is minimized. The positioning of the fastening stub and thus of the ultrasonic probe is so precise that a costly mechanical reworking after the welding can possibly be omitted.

The fastening stub is preferably moved towards the housing during the positioning until at least one spacer arranged at the outer wall of the housing abuts an end face of the fastening stub. This ensures a defined welding gap and enables a reliable through-welding. In particular if a plurality of fastening stubs are present, it is advisable to provide the housing with appropriate spacers before the moving towards of the fastening stubs. However, it is generally also possible to move the fastening stub towards the housing during the positioning until at least one spacer arranged at an end face of the fastening stub abuts the outer wall of the housing.

It may be that the spacer is bolt-shaped and is inserted into a bolt receiver of the housing. The bolt receiver can be formed as a continuous bore in the outer wall of the housing.

The fastening stub can be moved towards the housing during the positioning such that at least one positioning pin arranged at the outer wall of the housing enters into a pin receiver of the fastening stub. An exact positioning of the fastening stub is thereby ensured. In particular if a plurality of fastening stubs are present, it is favorable to provide the housing with positioning pins before the moving towards of the fastening stubs. However, it is generally also possible to move the fastening stub towards the housing during the positioning until at least one positioning pin arranged at the fastening stub enters into a pin receiver of the housing.

The positioning pin can be inserted into a pin receiver of the housing. The pin receiver can be formed as a continuous bore in the outer wall of the housing.

One embodiment of the invention provides that the fastening stub is clamped against the housing by means of a clamping tool during the welding, in particular wherein the clamping tool is brought into contact with a clamping tool engagement surface of the fastening stub, said clamping tool engagement surface preferably extending at a right angle to the stub axis. As a result, the welding distortion can in particular be minimized.

One embodiment of the invention provides that at least one passage hole for ultrasonic signals is formed in the housing before the positioning of the fastening stub and that the fastening stub is positioned such that the passage hole is aligned with the receiver for the ultrasonic probe. Depending on the application, the ultrasonic probe can project into or even through the passage hole.

In the case of a housing with a curved outer wall, the outer wall can be provided with at least one planar surface section before the positioning of the fastening stub, for example by making a cut-out in the material of the housing or by applying a base to the material of the housing. However, as already described above, the fluid line is often already so large in comparison to the fastening stub that a curvature of the transition region between the lateral surface of the fastening stub and the outer wall of the housing is practically negligible and virtually does not affect the welding even without such an additional measure.

Further developments of the invention can also be seen from the dependent claims, from the description, and from the enclosed drawings.

The invention will be described in the following by way of example with reference to the drawings.

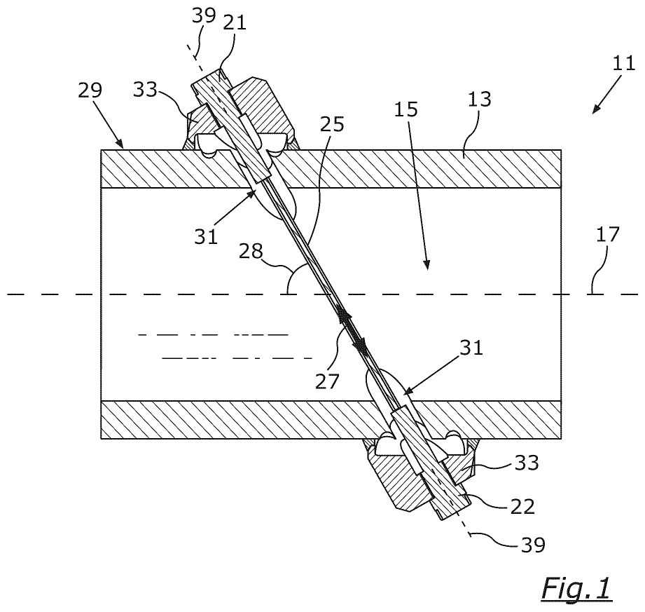

FIG. 1 shows a throughflow measurement system according to the invention in a lateral sectional view;

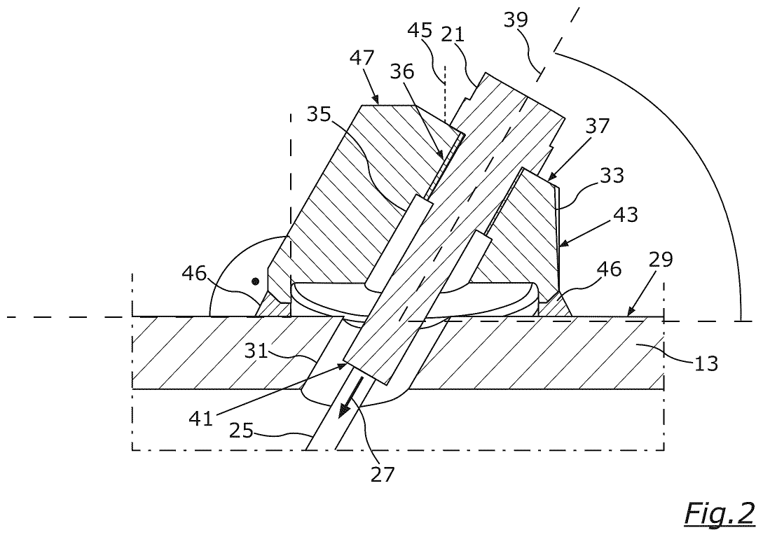

FIG. 2 is an enlarged part representation of the throughflow measurement system shown in FIG. 1;

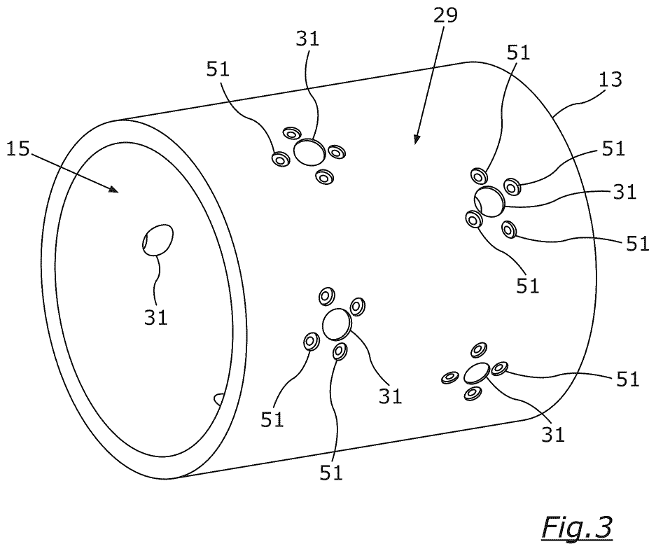

FIG. 3 shows a housing of the throughflow measurement system shown in FIG. 1 before the insertion of positioning pins and spacers;

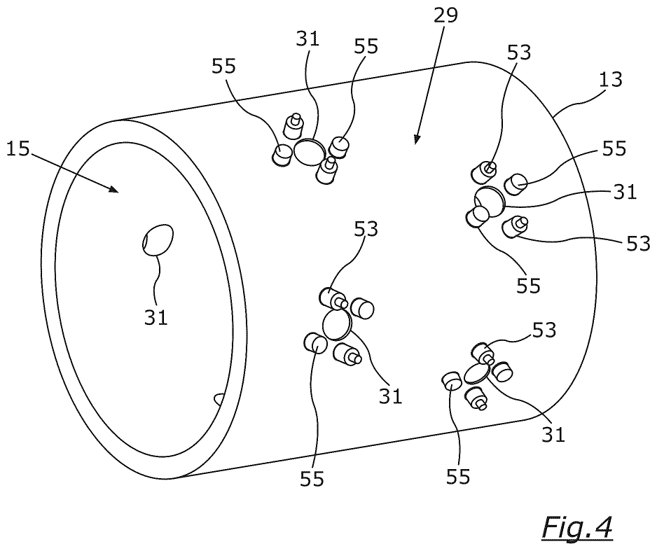

FIG. 4 shows the housing in accordance with FIG. 3 with inserted positioning pins and spacers;

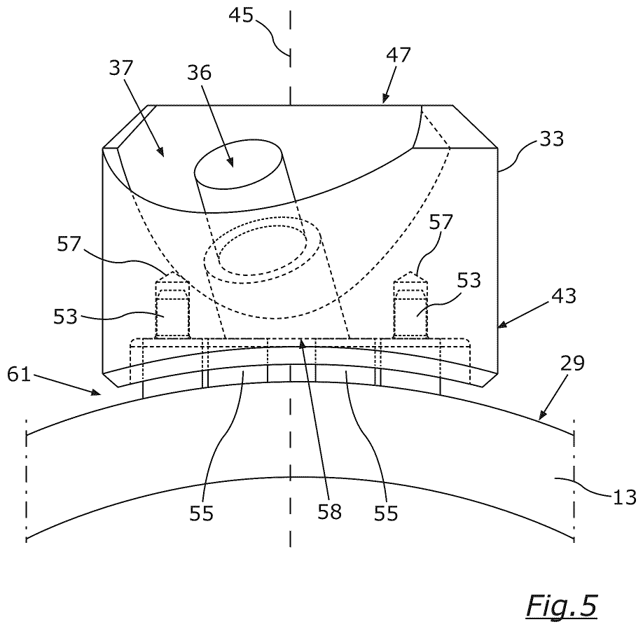

FIG. 5 shows a fastening stub moved towards the housing in accordance with FIG. 4; and

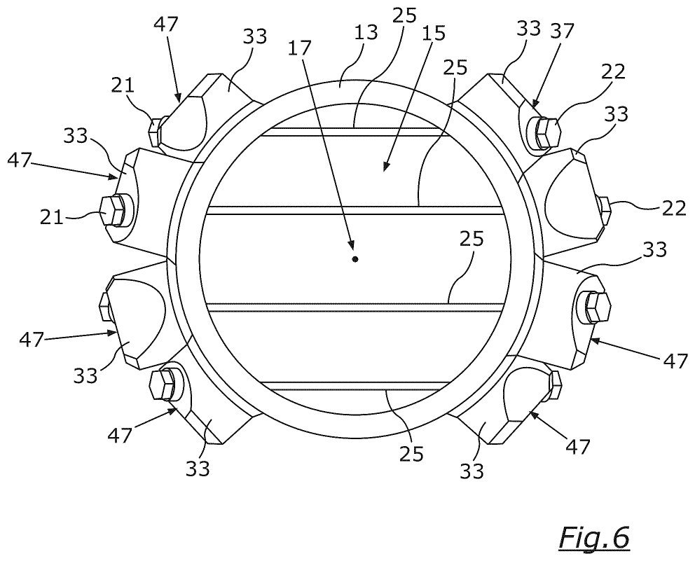

FIG. 6 shows the housing in accordance with FIG. 4 with a plurality of welded-on fastening stubs.

The throughflow measurement system 11 shown in FIG. 1 that is designed according to one embodiment of the invention comprises a housing 13 made of metal, preferably a single-piece housing, that has a fluid channel 15. As shown, the fluid channel 15 is rectilinear and defines a channel axis 17. In the embodiment example shown, the housing 13 is tubular, wherein the fluid channel 15 has a circular cross-section. For the installation in a fluid line system, not shown, the housing 13 can be provided with end-face screw flanges, which is not shown in FIG. 1, however.

Two ultrasonic probes 21, 22, between which a measurement path 25 extending obliquely to the channel axis 17 is formed, are fastened to the housing. This means that the radiation directions 27 or signal directions of the ultrasonic probes 21, 22 do not extend in parallel and do not extend at a right angle to the channel axis 17, but at an oblique angle 28. Respective passage openings 31 are provided for the passage of the ultrasonic signals through the wall 29 of the housing 13. The ultrasonic probes 21, 22 are connected to an electronic control and evaluation unit, not shown, of the throughflow measurement system 11.

The ultrasonic probes 21, 22 are seated in respective fastening stubs 33 that are welded to the outside of the wall 29 of the housing 13. One of the two similar fastening stubs 33 with an associated ultrasonic probe 21 is shown enlarged in FIG. 2. The ultrasonic probe 21 is sectionally cylindrical and has a longitudinal axis 39 that coincides with the radiation direction 27. The signal transmission surface 41 of the ultrasonic probe 21 extends at a right angle to the longitudinal axis 39, i.e. the ultrasonic probe 21 is not designed as cranked.

A central recess 35 of the fastening stub 33 is aligned with the passage hole 31 and forms a receiver 36 for the ultrasonic probe 21, wherein a planar contact surface 37, which extends obliquely to the channel axis 17 (FIG. 1), for the ultrasonic probe 21 ensures that the longitudinal axis 39 of the ultrasonic probe 21 extends obliquely to the channel axis 17 when the ultrasonic probe 21 is seated in the receiver 36.

The fastening stub 33 has a cylindrical lateral surface 43 by which a stub axis 45 of the fastening stub 33 is defined. The cylindrical lateral surface 43 revolves around the stub axis 45 and extends up to the wall 29 of the housing 13. The stub axis 45 extends at a right angle to the channel axis 17, i.e. the fastening stub 33 is welded at a right angle to the housing 13. The respective weld seam 46 at the transition from the cylindrical lateral surface 43 and the wall 29 of the housing 13 runs around completely.

Since the cylindrical lateral surface 43 of the fastening stub 33 does not adjoin the housing 13 obliquely but at a right angle thereto, the distortion of the welding assembly is minimized. The orientation of the ultrasonic probe 21 is sufficiently accurate even if the welding takes place in an automated manner and a mechanical post-processing is omitted.

At an end facing away from the housing 13, the fastening stub 33 has a planar clamping tool engagement surface 47 that extends at a right angle to the stub axis 45, and thus parallel to the channel axis 17, when the fastening stub 33 is welded to the housing 13. Thus, the fastening stub 33 can be clamped against the housing 13 in a favorable manner during the welding process.

With reference to FIGS. 3-5, a method according to the invention for manufacturing the throughflow measurement system 11 shown in FIG. 1 is described below.

First, a tubular housing 13 is provided. As shown in FIG. 3, a plurality of passage openings 31 for ultrasonic signals and non-continuous reception bores 51 arranged distributed around the passage openings 31 are formed in the wall 29 of the housing 13. Positioning pins 53 and spacer bolts 55 are inserted (FIG. 4), preferably in a clamping manner, into the reception bores 51. As shown, a respective two positioning pins 53 and two spacer bolts 55 are arranged disposed opposite one another with respect to a passage opening 31.

Then, for each of the passage openings 31, a fastening stub 33 designed as described above is provided and is oriented so that the stub axis 45 extends at a right angle to the channel axis 17 of the housing 13. Each fastening stub 33 is moved towards the housing 13 such that the positioning pins 53 enter into pin receivers 57 of the fastening stub 33, as shown in FIG. 5. The moving of the fastening stub 33 towards the housing 13 is continued until the spacer bolts 55 abut a planar end face 58 of the fastening stub 33 and a uniform air gap 61 is formed between the wall 29 of the housing 13 and the fastening stub 33.

By means of a clamping tool (not shown) acting on the clamping tool engagement surface 47 in an axial direction with respect to the stub axis 45, the fastening stub 33 is clamped against the housing 13 and is thus fixed. The clamping tool does not have to fulfill a positioning function since this function is fulfilled by the positioning pins 53. Then, the fastening stub 33 is welded to the wall 29 of the housing 13 by means of a welding apparatus, not shown, wherein the weld seam 46 (FIG. 2) is formed.

The ultrasonic probes 21, 22 are then inserted into the receivers 36 of the fastening stubs 33. As a result, the radiation direction 27 of each ultrasonic probe 21, 22 extends obliquely to the channel axis 17. However, this oblique orientation of the ultrasonic signals is not caused by an oblique orientation of the fastening stub 33 relative to the housing 13, but by an oblique orientation of the ultrasonic probe 21 relative to the fastening stub 33.

The fixing of the fastening stubs 33 to the housing 13 is in particular simplified in that, as can be seen in FIG. 6, for each pair of fastening stubs 33, there are clamping tool engagement surfaces 47 which extend in parallel with one another, which are disposed opposite one another with respect to the channel axis 17 and which can be acted on in opposite directions.

Milled portions could also be provided at the housing 13 to position the fastening stubs 33. Furthermore, two or more receivers 36 comprising ultrasonic probes 21, 22 could be provided in a single fastening stub 33. The length of the fastening stubs 33 can be matched to the thickness of the wall 29.

A throughflow measurement system 11 according to the invention can be easily designed as suitable for high pressure due to the favorable welding geometry. A precise positioning of all the ultrasonic probes 21, 22 is ensured even if no mechanical reworking is performed after the welding.

### REFERENCE NUMERAL LIST

11 throughflow measurement system
13 housing
15 fluid channel
17 channel axis
21 ultrasonic probe
22 ultrasonic probe
25 measurement path
27 radiation direction
28 oblique angle
29 wall
31 passage hole
33 fastening stub
35 recess
36 receiver
37 contact surface
39 longitudinal axis
41 signal transmission surface
43 cylindrical lateral surface
45 stub axis
46 weld seam
47 clamping tool engagement surface
51 reception bore
53 positioning pin
55 spacer bolt
57 pin receiver
58 end face
61 air gap

1. A throughflow measurement system for measuring a fluid throughflow in a fluid line, said throughflow measurement system comprising:
a housing that has a fluid channel and that defines a channel axis by means of the course of the fluid channel,
at least one ultrasonic probe that can be fastened to the housing and that has a radiation direction, wherein,
for fastening the ultrasonic probe to the housing, a fastening stub is provided that is welded to the outer wall of the housing and that has a receiver for the ultrasonic probe, wherein the radiation direction of the ultrasonic probe extends obliquely to the channel axis when the ultrasonic probe is arranged in the receiver,
wherein the fastening stub has a lateral surface that revolves around a stub axis extending at a right angle to the channel axis and that extends, starting from a housing-side end region of the fastening stub, in the direction of the stub axis, wherein a peripheral weld seam is formed in the transition region between the lateral surface of the fastening stub and the outer wall of the housing.

2. The throughflow measurement system according to claim 1,
wherein the fluid line is a high pressure line.

3. The throughflow measurement system according to claim 1,
wherein the lateral surface has a cylindrical shape and defines a cylinder axis that extends in parallel with the stub axis and preferably coincides therewith.

4. The throughflow measurement system according to claim 1,
wherein the fastening stub has at least one contact surface for the ultrasonic probe, said contact surface extending obliquely to the stub axis.

5. The throughflow measurement system according to claim 4,
wherein the at least one contact surface is a planar contact surface.

6. The throughflow measurement system according to claim 1,
wherein the fastening stub has a planar clamping tool engagement surface that extends at a right angle to the stub axis.

7. The throughflow measurement system according to claim 1,
wherein the ultrasonic probe has a longitudinal axis coinciding with the radiation direction and a signal transmission surface extending at a right angle to the longitudinal axis.

8. The throughflow measurement system according to claim 1,
wherein at least one spacer projects from the outer wall of the housing and contacts a boundary surface of the fastening stub.

9. The throughflow measurement system according to claim 1,
wherein at least one positioning pin projects from the outer wall of the housing and is received in a pin receiver of the fastening stub.

10. The throughflow measurement system according to claim 1,
wherein at least one passage hole, which is in alignment with the receiver, for ultrasonic signals of the ultrasonic probe is formed in the housing.

11. The throughflow measurement system according to claim 1,
wherein the throughflow measurement system has at least one further ultrasonic probe that can be fastened to the housing, wherein a measurement path extending obliquely to the channel axis is formed between the two ultrasonic probes fastened to the housing.

12. The throughflow measurement system according to claim 1,
wherein the housing is at least sectionally tubular.

13. The throughflow measurement system according to claim 12,
wherein the housing is provided with screw flanges at both ends.

14. A method for fastening an ultrasonic probe, which has a radiation direction, to a housing that has a fluid channel and that defines a channel axis by means of the course of the fluid channel, comprising the steps:
providing a fastening stub that has a receiver for the ultrasonic probe and a lateral surface that revolves around a stub axis and that extends, starting from an end region of the fastening stub, in the direction of the stub axis, positioning the fastening stub relative to the housing such that there is an air gap between the end region and the outer wall of the housing and the stub axis extends at a right angle to the channel axis,
welding the fastening stub to the outer wall of the housing while forming a peripheral weld seam in the region of the air gap, and
inserting the ultrasonic probe into the receiver of the fastening stub such that the radiation direction of the ultrasonic probe extends obliquely to the stub axis.

15. The method according to claim 14,
wherein the fastening stub is moved towards the housing during the positioning until at least one spacer arranged at the outer wall of the housing abuts an end face of the fastening stub.

16. The method according to claim 15,
wherein the spacer is bolt-shaped and is inserted into a bolt receiver of the housing.

17. The method according to claim 14,
wherein the fastening stub is moved towards the housing during the positioning such that at least one positioning pin arranged at the outer wall of the housing enters into a pin receiver of the fastening stub.

18. The method according to claim 17,
wherein the positioning pin is inserted into a pin receiver of the housing.

19. The method according to claim 14,
wherein the fastening stub is clamped against the housing by means of a clamping tool during the welding.

20. The method according to claim 14,
wherein at least one passage hole for ultrasonic signals is formed in the housing before the positioning of the fastening stub and the fastening stub is positioned such that the passage hole is aligned with the receiver for the ultrasonic probe.
